(19) United States
(12) Patent Application Publication
(10) Pub. No.: US 2018/0314104 A1
(43) Pub. Date: Nov. 1, 2018

(54) DISPLAY DEVICE

(71) Applicant: Japan Display Inc., Minato-ku (JP)

(72) Inventors: Toshiyuki HIGANO, Tokyo (JP); Emi Higano, Tokyo (JP)

(73) Assignee: Japan Display Inc., Minato-ku (JP)

(21) Appl. No.: 15/946,824

(22) Filed: Apr. 6, 2018

(30) Foreign Application Priority Data
Apr. 27, 2017 (JP) 2017-088494

(51) Int. Cl. G02F 1/1333; G02F 1/1337; G02F 1/1343; G02F 1/1339; G02F 1/1335

(52) U.S. Cl. CPC G02F 1/133345; G02F 1/1337; G02F 1/134309; G02F 1/1339; G02F 2201/123; G02F 1/133514; G02F 1/133512; G02F 2201/121; G02F 1/133305

(57) ABSTRACT

According to one embodiment, a display device comprises a first substrate, a flexible second substrates, an adhesive layer, a terminal, an electrode and a conductive structure. The terminal is in the first substrate and is connected to a drive circuit. The electrode is provided in the second substrate. The conductive structure connects the drive circuit and the electrode. The conductive structure comprises a first protrusion provided in the first surface in an area overlapping the adhesive layer, a first conductive film covering the first protrusion, a second conductive film facing the first conductive film, and a conductive member in the adhesive layer.

### CROSS-REFERENCE TO RELATED APPLICATIONS

This application is based upon and claims the benefit of priority from Japanese Patent Application No. 2017-088494, filed Apr. 27, 2017, the entire contents of which are incorporated herein by reference.

### FIELD

Embodiments described herein relate generally to a display device.

### BACKGROUND

Recently, display devices such as liquid crystal display devices have been used in various fields. A liquid crystal display device comprises an array substrate, a counter-substrate and a liquid crystal layer provided between the substrates. In the counter-substrate, electrodes for a touch sensor may be provided.

The conductive film provided in the counter-substrate like the above electrodes is electrically continuous with the conductive film of the array substrate via, for example, a conductive material provided between the array substrate and the counter-substrate. In this conductive structure, improvement is required to prevent a conduction defect.

### BRIEF DESCRIPTION OF THE DRAWINGS

FIG. 1 is a schematic plan view of a display device according to a first embodiment.

FIG. 2 schematically shows a structure related to the image display of the display device according to the first embodiment.

FIG. 3 schematically shows a structure related to the sensing operation of the display device according to the first embodiment.

FIG. 4 is a schematic cross-sectional view of a display panel according to the first embodiment.

FIG. 5 is a schematic plan view of the display device according to the first embodiment.

FIG. 6 is a schematic cross-sectional view of the display panel along the line VI-VI of FIG. 5.

FIG. 7 is a schematic cross-sectional view of the display panel according to a modification example.

FIG. 8 is a schematic plan view of a conductive structure according to the first embodiment.

FIG. 9 is a schematic cross-sectional view of the display panel along the line IX-IX of FIG. 8.

FIG. 10 is a plan view for explaining the effects of the first embodiment.

FIG. 11 is a cross-sectional view for explaining the effects of the first embodiment.

FIG. 12 is a schematic plan view of a conductive structure according to a second embodiment.

FIG. 13 is a schematic plan view of a conductive structure according to a third embodiment.

FIG. 14 is a schematic plan view of a conductive structure according to a fourth embodiment.

FIG. 15 is a schematic perspective view of a display panel according to the fourth embodiment.

FIG. 16 is a schematic plan view of a conductive structure according to a fifth embodiment.

FIG. 17 is a schematic plan view of a conductive structure according to a sixth embodiment.

FIG. 18 is a schematic plan view of a display device according to a seventh embodiment.

FIG. 19 is a schematic plan view of a display device according to an eighth embodiment.

### DETAILED DESCRIPTION

In general, according to one embodiment, a display device comprises a first substrate, a second substrate, an adhesive layer, a terminal, an electrode and a conductive structure. The first substrate comprises a first surface. The second substrate comprises a second surface facing the first surface. The adhesive layer attaches the first substrate to the second substrate. The terminal is provided in one of the first and second substrates and is connected to a drive circuit. The electrode is provided in the other one of the first and second substrates. The conductive structure electrically connects the drive circuit and the electrode. The second substrate has flexibility. The conductive structure comprises a first protrusion provided in the first surface in an area overlapping the adhesive layer, a first conductive film covering at least a part of the first protrusion, a second conductive film provided in the second substrate and facing the first conductive film, and a conductive member which is included in the adhesive layer and is in contact with the first conductive film and the second conductive film.

This structure enables the achievement of a display device which can improve the manufacturing yield.

Embodiments will be described with reference to the accompanying drawings.

The disclosure is merely an example, and proper changes in keeping with the spirit of the invention, which are easily conceivable by a person of ordinary skill in the art, come within the scope of the invention as a matter of course. In addition, in some cases, in order to make the description clearer, the drawings show schematic illustration rather than as an accurate representation of what is implemented. However, such schematic illustration is merely exemplary, and in no way restricts the interpretation of the invention. In the drawings, reference numbers of continuously arranged elements equivalent or similar to each other are omitted in some cases. In addition, in the specification and drawings, structural elements which function in the same or a similar manner to those described in connection with preceding drawings are denoted by like reference numbers, detailed description thereof being omitted unless necessary.

In this specification, the phrases “a includes A, B or C”, “a includes one of A, B and C” and “a includes an element selected from a group consisting of A, B and C” do not exclude a case where a includes a plurality of combinations of A to C unless specified. Further, these phrases do not exclude a case where a includes other elements.

In this specification, the expressions “first” “second” and “third” of “the first member, the second member and the third member” are merely ordinal numbers used to explain the elements for the sake of convenience. Thus, the expression “A comprises the third member” includes a case where A does not comprise the first member and the second member unless otherwise specified.

In each embodiment, a liquid crystal display device comprising a touch sensor is disclosed as an example of a display device. This liquid crystal display device may be used for various devices such as a smartphone, a tablet, a mobile phone, a notebook computer, a vehicle-mounted device and a game console. The main structure disclosed in the embodiments may be applied to, for example, a self-luminous display device such as an organic electroluminescent display device, an electronic paper display device comprising an electrophoretic element, etc., a display device to which micro-electromechanical systems (MEMS) are applied or a display device to which electrochromism is applied.

### First Embodiment

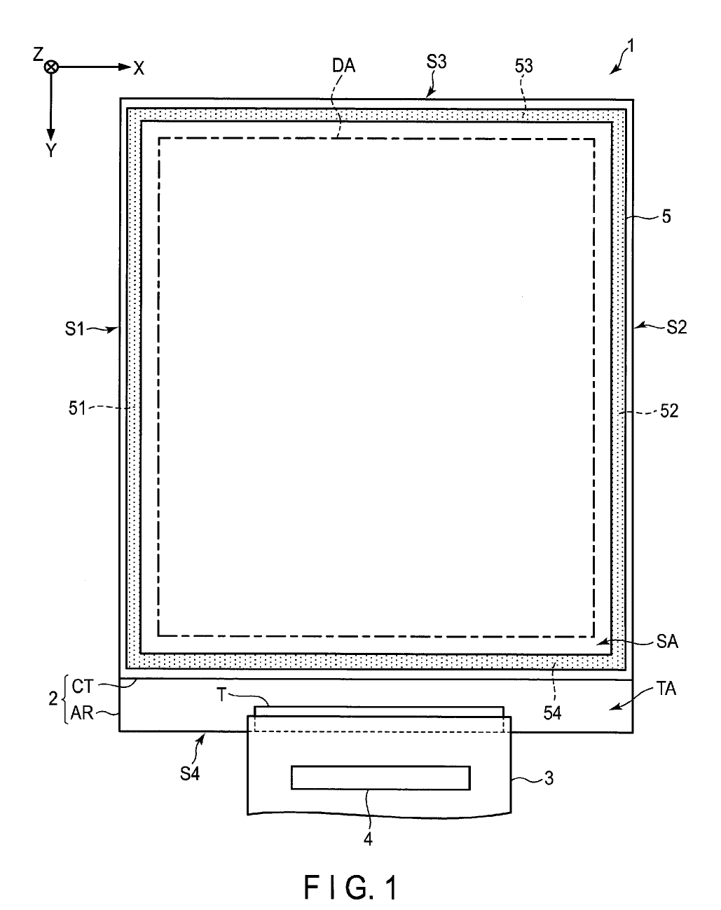

FIG. 1 is a schematic plan view of a liquid crystal display device 1 (hereinafter, referred to as a display device 1) according to a first embodiment. The display device 1 comprises a display panel 2, a flexible printed circuit 3 and a drive circuit 4. In the present embodiment, an X-direction, a Y-direction and a Z-direction are defined as shown in FIG. 1. These directions are perpendicular to one another in the present embodiment. However, they may intersect one another at an angle other than a right angle.

The display panel 2 comprises an array substrate AR, a counter-substrate CT, a sealant 5 (sealing member) and a liquid crystal layer (the liquid crystal layer LC described later). One of the array substrate AR and the counter-substrate CT is equivalent to a first substrate in the present embodiment, and the other is equivalent to a second substrate in the present embodiment. The sealant 5 is an example of an adhesive layer with which the array substrate AR is attached to the counter-substrate CT. The liquid crystal layer is provided in the space surrounded by the array substrate AR, the counter-substrate CT and the sealant 5.

The array substrate AR comprises a first side S1, a second side S2 opposite to the first side, and third and fourth sides S3 and S4 connecting the first side S1 and the second side S2. As seen in plan view, the display panel 2 comprises a display area DA surrounded by the first to fourth sides S1 to S4, a peripheral area SA around the display area DA, and a terminal area TA along the fourth side S4. In the example of FIG. 1, the first and second sides S1 and S2 are parallel to the Y-direction, and the third and fourth sides S3 and S4 are parallel to the X-direction. In the display area DA and the peripheral area SA, the array substrate AR faces the counter-substrate CT. However, in the terminal area TA, only the array substrate AR is present.

A terminal T is provided in the terminal area TA. The flexible printed circuit 3 is electrically connected to the terminal T. The drive circuit 4 is, for example, an IC, and includes a circuit for controlling display and sensing. A circuit which controls display and a circuit which controls sensing may be separately provided. In the example of FIG. 1, the drive circuit 4 is mounted on the flexible printed circuit 3. The drive circuit 4 may be mounted at a different position such as the terminal area TA.

The sealant 5 has, for example, a rectangular frame shape as shown in FIG. 1, and comprises a first portion 51 along the first side S1, a second portion 52 along the second side S2, a third portion 53 along the third side S3, and a fourth portion 54 along the fourth side S4. The first to fourth portions 51 to 54 are provided between the display area DA and the first to fourth sides S1 to S4, respectively.

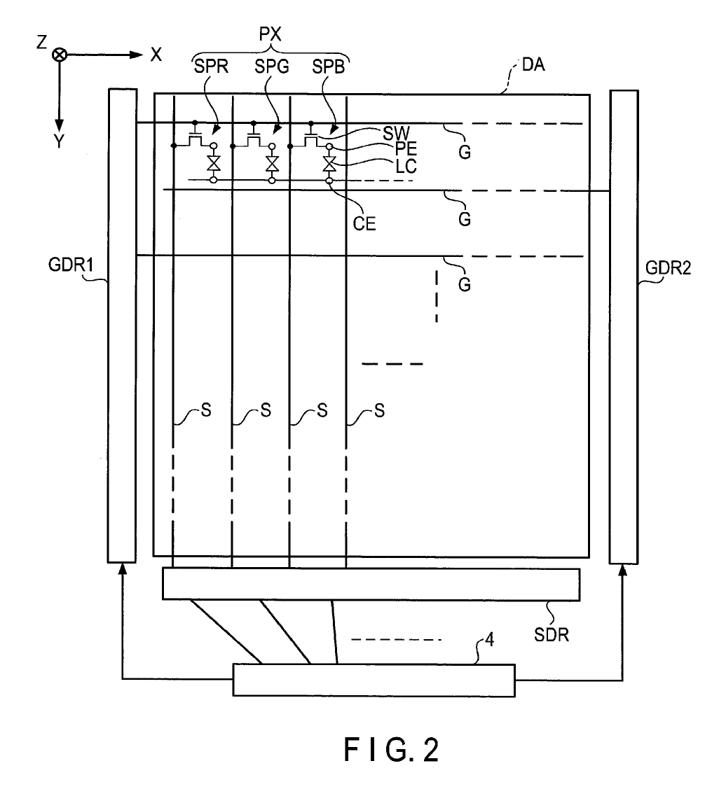

FIG. 2 schematically shows a structure related to the image display of the display device 1. The display device 1 comprises a plurality of scanning lines G, a plurality of signal lines S, scanning line drivers GDR1 and GDR2, and a signal line driver SDR. The scanning lines G extend in the X-direction and are arranged in the Y-direction in the display area DA. The signal lines S extend in the Y-direction and are arranged in the X-direction in the display area DA. For example, the odd-numbered scanning lines G from the top of FIG. 2 are connected to the scanning line driver GDR1, and the even-numbered scanning lines G are connected to the scanning line driver GDR2. The signal lines S are connected to the signal line driver SDR. The scanning line drivers GDR1 and GDR2 supply a scanning signal to the scanning lines G. The signal line driver SDR supplies a video signal to the signal lines S. The drive circuit 4 controls the operation of the drivers GDR1, GDR2 and SDR. The display device 1 may comprise only one scanning line driver.

An area defined by two scanning lines G and two signal lines S is equivalent to a subpixel SP. For example, each pixel PX which is the minimum unit of image display includes subpixels SPR, SPG and SPB corresponding to red, green and blue, respectively. The structure of each pixel PX is not limited to this example. Each pixel PX may further include a subpixel SP corresponding to another color such as white. Each subpixel SP includes a switching element SW, a pixel electrode PE and a common electrode CE. Each switching element SW is connected to a corresponding scanning line G, a corresponding signal line S and a corresponding pixel electrode PE.

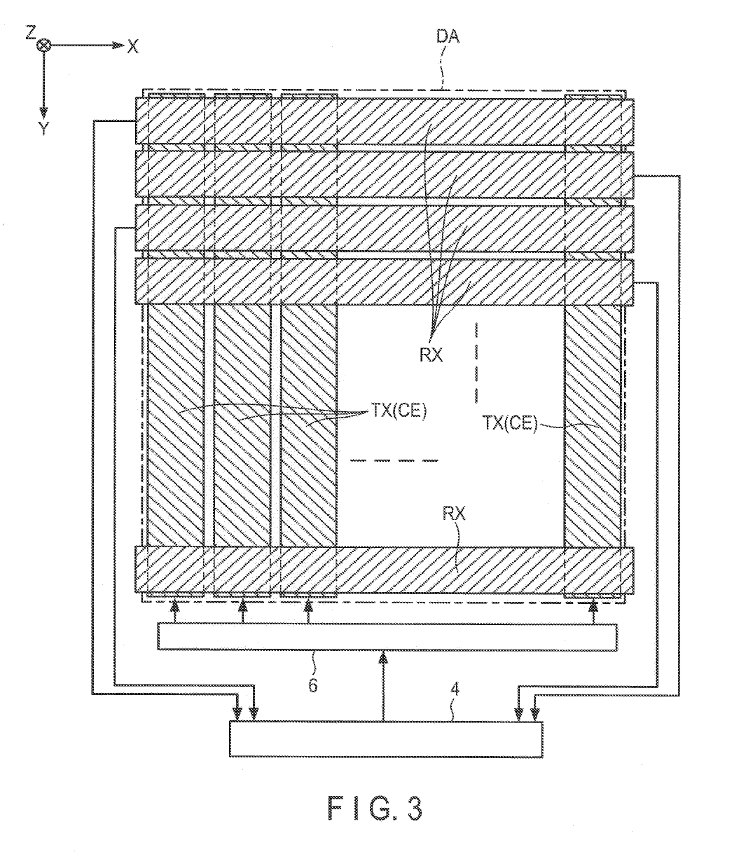

FIG. 3 schematically shows a structure related to the sensing operation of the display device 1. The display device 1 comprises a plurality of drive electrodes TX as sensing electrodes, a plurality of detection electrodes RX as sensing electrodes, and a switching circuit 6. The drive electrodes TX extend in the Y-direction and are arranged in the X-direction in the display area DA. The detection electrodes RX extend in the X-direction and are arranged in the Y-direction in the display area DA.

In the present embodiment, common electrodes CE are used for the drive electrodes TX. However, the drive electrodes TX and the common electrodes CE may be separate electrodes. In the present embodiment, the drive electrodes TX (common electrodes CE) are provided in the array substrate AR, and the detection electrodes RX are provided in the counter-substrate CT. However, the drive electrodes TX may be provided in the counter-substrate CT, and the detection electrodes RX may be provided in the array substrate AR. Further, in this case, the common electrodes CE may be used for the detection electrodes RX.

To display an image, the switching circuit 6 applies common voltage to the common electrodes CE. At the time of sensing, the switching circuit 6 supplies a drive signal to the common electrodes CE in series. Capacitance is formed between the detection electrodes RX and the common electrodes CE. Thus, when a drive signal is supplied, a detection signal is output from the detection electrodes RX to the drive circuit 4. The drive circuit 4 is capable of detecting the presence or absence of a conductor which is close to or in contact with the display area DA or the position of the conductor based on the detection signal.

The common electrodes CE may be formed of a transparent conductive material such as indium tin oxide (ITO). The detection electrodes RX may be formed of, for example, conductive lines connected in a lattice form. The conductive lines may have, for example, a multilayer structure including metal and ITO, or a single-layer structure.

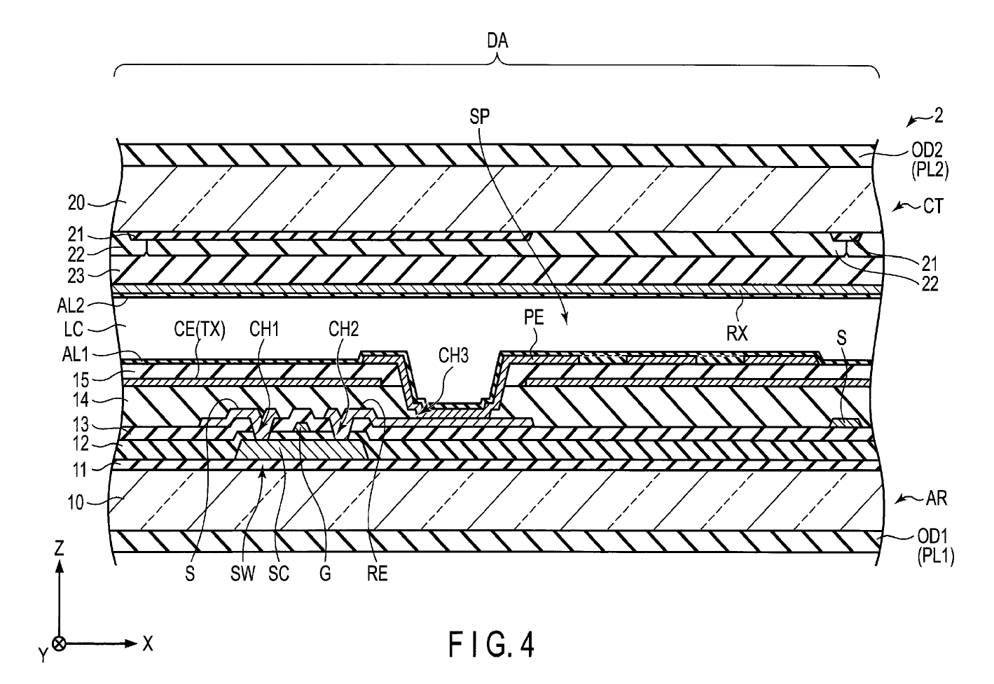

FIG. 4 is a schematic cross-sectional view of the display panel 2 in the display area DA. In the following explanation, the Z-direction is referred to as “upward”. The opposite direction is referred to as “downward”.

The array substrate AR comprises the switching elements SW, the pixel electrodes PE, the common electrodes CE, the scanning lines G and the signal lines S as described above, and further comprises a first base 10, insulating layers 11 to 15, a first alignment film AL1 and a relay electrode RE.

The insulating layer 11 covers the upper surface of the first base 10. The semiconductor layer SC of the switching element SW is provided on the insulating layer 11. The insulating layer 12 covers the semiconductor layer SC and the insulating layer 11. The scanning line G is provided on the insulating layer 12. The insulating layer 13 covers the scanning line G and the insulating layer 12. The signal line S and the relay electrode RE are provided on the insulating layer 13. The signal line S is in contact with the semiconductor layer SC via a contact hole CH1 penetrating the insulating layers 12 and 13. The relay electrode RE is in contact with the semiconductor layer SC via a contact hole CH2 penetrating the insulating layers 12 and 13. The signal line S, the relay electrode RE and the insulating layer 13 are covered with the insulating layer 14.

The common electrode CE is provided on the insulating layer 14. The insulating layer 15 covers the common electrode CE and the insulating layer 14. The pixel electrode PE is provided on the insulating layer 15. The pixel electrode PE is in contact with the relay electrode RE via a contact hole CH3 penetrating the insulating layers 14 and 15. The first alignment film AL1 covers the pixel electrode PE and the insulating layer 15.

The counter-substrate CT comprises the detection electrodes RX described above, and further comprises a second base 20, a light-shielding layer 21, a color filter 22, an overcoat layer 23 and a second alignment film AL2.

The light-shielding layer 21 is provided on the lower surface of the second base 20. The color filter 22 covers the light-shielding layer 21 and the lower surface of the second base 20. The overcoat layer 23 covers the color filter 22. The detection electrode RX is provided under the overcoat layer 23. The second alignment film AL2 covers the detection electrode RX. The position of the detection electrode RX is not limited to the example shown in FIG. 4. For example, the detection electrode RX may provided between the color filter 22 and the overcoat layer 23.

The liquid crystal layer LC containing liquid crystal molecules are sealed between the alignment films AL1 and AL2. The light-shielding layer 21 faces the switching element SW, the scanning line G and the signal line S, and opens in an area corresponding to a subpixel SP.

A first optical element OD1 including a first polarizer PL1 is provided on the lower surface of the first base 10. A second optical element OD2 including a second polarizer PL2 is provided on the upper surface of the base 20.

In the present embodiment, the first and second bases 10 and 20 are resinous substrates formed of a resinous material such as polyimide. The array substrate AR and the counter-substrate CT have flexibility. At least one of the first and second bases 10 and 20 may be a rigid substrate such as a glass substrate.

The structure of the display panel 2 is not limited to the example of FIG. 4. For example, in FIG. 4, the pixel electrode PE is provided between the common electrode CE and the liquid crystal layer LC. However, the common electrode CE may be provided between the pixel electrode PE and the liquid crystal layer LC.

In the present embodiment, the detection electrodes RX are electrically connected to the drive circuit 4 via the terminal T. Now, this specification explains a structure for allowing the detection electrodes RX to be electrically continuous with the drive circuit 4.

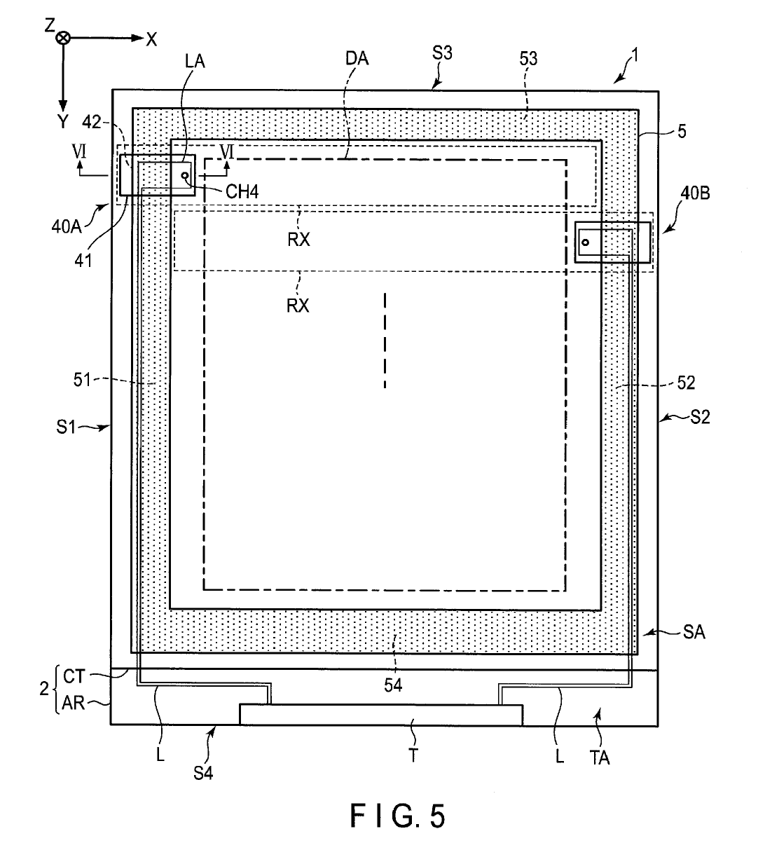

FIG. 5 is a schematic plan view of the display device 1. To simplify explanation, in FIG. 5, the peripheral area SA is larger than that of FIG. 1. The display device 1 comprises a plurality of conductive structures 40 (40A and 40B) overlapping the sealant 5, and a plurality of lines L provided in the array substrate AR. Each detection electrode RX indicated with broken lines is connected to the terminal T via a corresponding conductive structure 40 and a corresponding line L. In other words, the sensing electrodes (the detection electrodes RX in the present embodiment) formed in the counter-substrate CT are connected to the conductive structures 40 different from each other.

For example, the odd-numbered detection electrodes RX from the third side S3 are connected to the lines L passing between the first side S1 and the display area DA via the conductive structures 40A provided between the first side S1 and the display area DA. The even-numbered detection electrodes RX from the third side S3 are connected to the lines L passing between the second side S2 and the display area DA via the conductive structures 40B provided between the second side S2 and the display area DA. All the conductive structures 40 may be provided between the first side S1 and the display area DA or between the second side S2 and the display area DA.

An end portion of each line L is connected to the terminal T. In the other end portion, each line L comprises an enlarged portion LA in which the width is great.

Each conductive structure 40 comprises a first conductive film 41 provided in the array substrate AR, and a second conductive film 42 provided in the counter-substrate CT. The first and second conductive films 41 and 42 may be formed of either a transparent conductive material such as ITO or a metal material.

The first conductive film 41 is electrically connected to the enlarged portion LA via a contact hole CH4 as described later. In the example of FIG. 5, the second conductive film 42 is a part of each detection electrode RX. The second conductive film 42 may be provided separately from each detection electrode RX and electrically connected to each detection electrode RX.

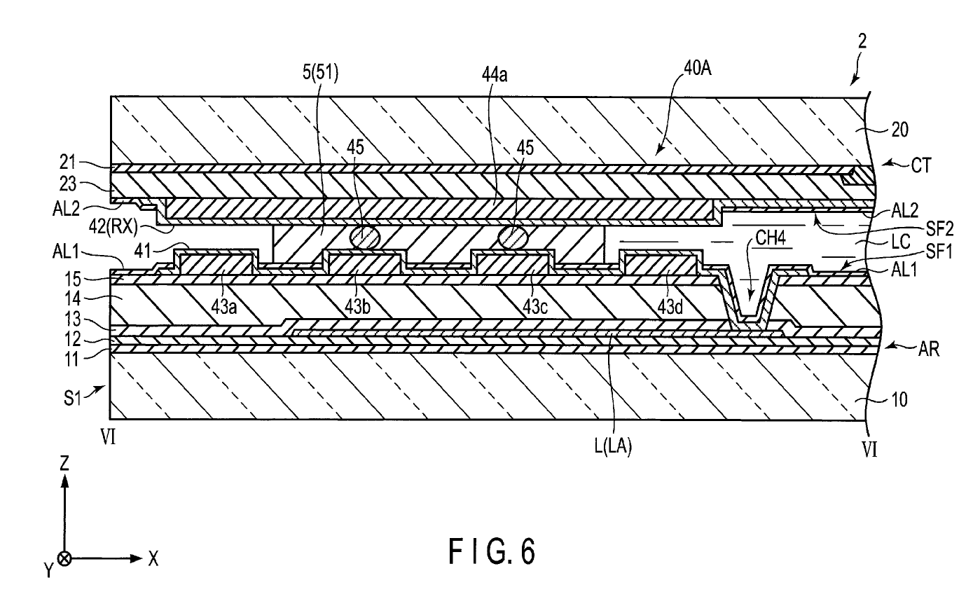

FIG. 6 is a schematic cross-sectional view of the display panel 2 along the line VI-VI of FIG. 5. Here, this specification explains the conductive structures 40A. It should be noted that the conductive structures 40B are the same as the conductive structures 40A. In the following explanation, the surface of the array substrate AR facing the counter-substrate CT is referred to as a first surface SF1. The surface of the counter-substrate CT facing the first surface SF1 is referred to as a second surface SF2.

The line L (enlarged portion LA) is provided between the insulating layers 12 and 13. The first conductive film 41 is in contact with the enlarged portion LA via the contact hole CH4 penetrating the insulating layers 13 to 15. The line L may be provided at a different position, such as between the first base 10 and the insulating layer 11, between the insulating layers 11 and 12, or between the insulating layers 13 and 14.

The conductive structure 40A comprises the first conductive film 41 and the second conductive film 42 as described above, and further comprises protrusions 43 provided in the first surface SF1, and protrusions 44 provided in the second surface SF2, and conductive members 45.

In the present embodiment, the conductive structure 40A comprises four protrusions 43 (43a to 43d) provided in the first surface SF1. For example, as shown in FIG. 6, the protrusions 43a to 43d are formed by a resinous layer provided on the insulating layer 15 and are covered with the first conductive film 41. The number of protrusions 43 provided in the conductive structure 40A is not limited to four.

In the present embodiment, the conductive structure 40A comprises two protrusions 44 (44a and 44b) provided in the second surface SF2 (see FIG. 9 explained later regarding the protrusion 44b). For example, as shown in FIG. 6, the protrusion 44a is formed by a resinous layer provided under the overcoat layer 23 and is covered with the second conductive film 42. The protrusion 44b has the same structure as the protrusion 44a. The number of protrusions 44 provided in the conductive structure 40A is not limited to two.

The alignment films AL1 and AL2 are formed on substantially the entire surface of the display area DA and the peripheral area SA. The end portions of the alignment films AL1 and AL2 are closer to the first side S1 than the protrusions 43a to 43d and the protrusions 44a and 44b of the conductive structure 40A. The end portions of the alignment films AL1 and AL2 are closer to the second side S2 than the protrusions 43a to 43d and the protrusions 44a and 44b of the conductive structure 40B.

In the top portions of the protrusions 43a to 43d and the protrusions 44a and 44b, the alignment films AL1 and AL2 are thin, and have substantially no thickness. Thus, the first conductive film 41 is not covered with the first alignment film AL1 between the protrusions 43a to 43d and the protrusions 44a and 44b. Similarly, the second conductive film 42 is not covered with the second alignment film AL2 between the protrusions 43a to 43d and the protrusions 44a and 44b.

In FIG. 6, the protrusions 43b and 43c are covered with the sealant 5. Neither the protrusion 43a nor the protrusion 43d is covered with the sealant 5. The conductive members 45 are provided inside the sealant 5 at least between the protrusions 43b and 43c and the protrusions 44a and 44b. In the present embodiment, the conductive members 45 are spherical conductive particles (conductive fillers). However, the conductive members 45 may not be spherical.

In FIG. 6, a single conductive member 45 is provided between the protrusion 43b and the protrusion 44a, and a single conductive member 45 is provided between the protrusion 43c and the protrusion 44a. However, a plurality of conductive members 45 may be provided between the protrusion 43b and the protrusion 44a, and a plurality of conductive members 45 may be provided between the protrusion 43c and the protrusion 44a. More conductive members 45 may be provided at other positions inside the sealant 5. The conductive members 45 are in contact with the conductive films 41 and 42. In this way, the drive circuit 4 is electrically connected to the detection electrodes RX via the lines L, the first conductive film 41, the conductive members 45 and the second conductive film 42.

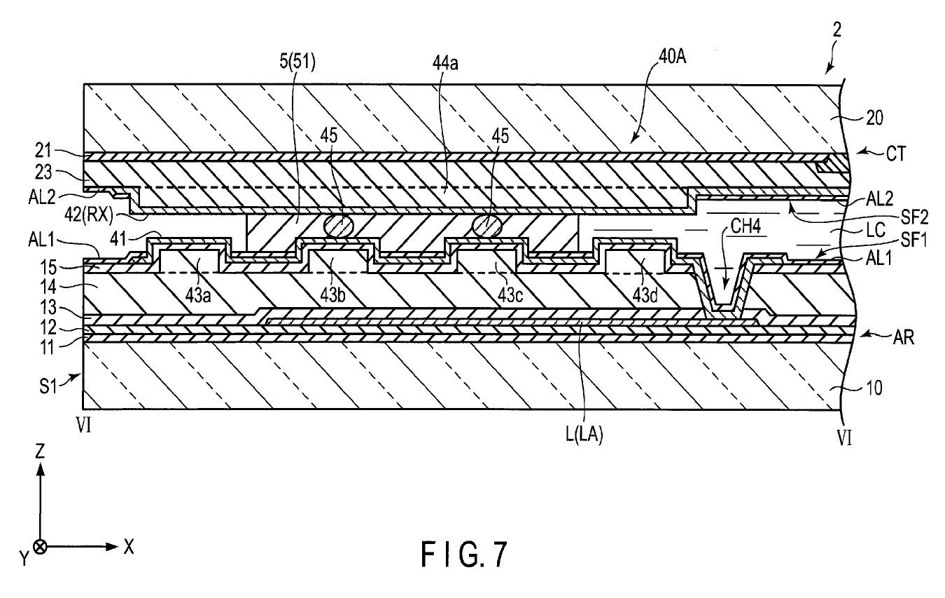

The form of the protrusions 43 or 44 is not limited to the example of FIG. 6. FIG. 7 is a schematic cross-sectional view of the display panel 2 according to a modification example. In the example of FIG. 7, the protrusions 43a to 43d are formed by changing the thickness of the insulating layer 14. The protrusion 44a is formed by changing the thickness of the overcoat layer 23. The protrusion 44b has the same structure as the protrusion 44a.

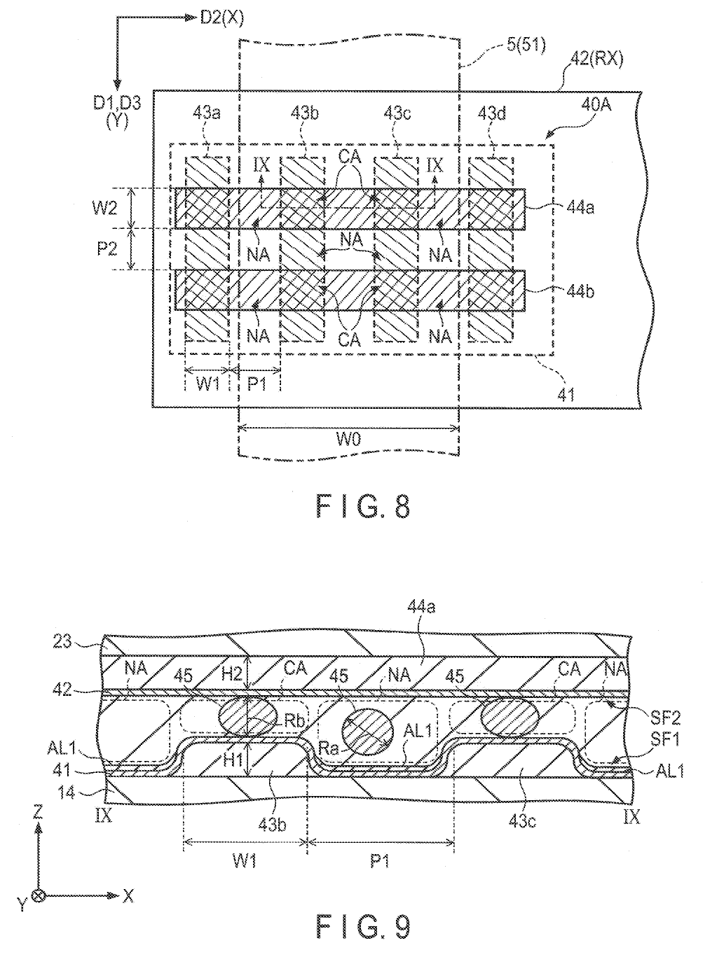

The conductive structure 40A is explained in more detail, using FIG. 8 and FIG. 9.

FIG. 8 is a schematic plan view of the conductive structure 40A. The protrusions 43a to 43d extend in a lengthy form in a first direction D1 and are arranged in a second direction D2. The protrusions 44a and 44b extend in a lengthy form in the second direction D2 and are arranged in the first direction D1. In the example of FIG. 8, the first direction D1 is parallel to the Y-direction, and the second direction D2 is parallel to the X-direction. In the present embodiment, the first direction D1 is perpendicular to the second direction D2. However, the first and second directions D1 and D2 may intersect at an angle other than a right angle. The first portion 51 of the sealant 5 extends in a third direction D3. In the present embodiment, the third direction D3 is parallel to the first direction D1.

As seen in plan view, neither the protrusion 43a nor the protrusion 43d overlaps the sealant 5. The protrusions 43b, 43c and the protrusions 44a and 44b overlap the sealant 5. A protrusion 44 which does not overlap the sealant 5 may be further provided.

As seen in plan view, the protrusions 44a and 44b intersect the protrusions 43a to 43d. In this manner, in the conductive structure 40A, eight intersection areas CA in which the protrusions 43 intersect the protrusions 44 are formed. Non-intersection areas NA in which only the protrusions 43 or the protrusions 44 are present are formed around the intersection areas CA. In the example of FIG. 8, the intersection areas CA formed by the protrusions 43b and 43c and the protrusions 44a and 44b overlap the sealant 5, and the other intersection areas CA do not overlap the sealant 5. In the intersection areas CA overlapping the sealant 5, the conductive film 41 is electrically connected to the conductive film 42 via the conductive members 45. Thus, these intersection areas CA substantially contribute to conduction.

FIG. 9 is a schematic cross-sectional view of the display panel 2 along the line IX-IX of FIG. 8. For example, the protrusions 43b and 43c may have a smooth surface as shown in FIG. 9. This structure is also applicable to the protrusions 43a and 43d and the protrusions 44a and 44b. On the protrusions 43a to 43d, the first alignment film AL1 is not formed, and the first conductive film 41 is exposed. Similarly, under the protrusions 44a and 44b, the second alignment film AL2 is not formed, and the second conductive film 42 is exposed. The first alignment film AL1 is formed around the protrusions 43a to 43d. The second alignment film AL2 is formed around the protrusions 44a and 44b.

The conductive members 45 are, for example, spherical. The conductive members 45 may be entirely formed of metal. Alternatively, an insulating material such as resin may be coated with a metal material to form the conductive members 45. The conductive members 45 are dispersed in the entire sealant 5. Thus, the conductive members 45 are present in the non-intersection areas NA as well as the intersection areas CA. For example, each conductive member 45 provided in the non-intersection areas NA is spherical such that the shape of the section is a precise circle. For example, the shape of the section of each conductive member 45 provided in the intersection areas CA is changed to an ellipse by the force applied when the array substrate AR is attached to the counter-substrate CT. By the deformed conductive members 45, the conductive film 41 is electrically continuous with the conductive film 42.

The first alignment film AL1 may be formed on the protrusions 43b and 43c so as to be thin. The second alignment film AL2 may be formed under the protrusions 44a and 44b so as to be thin. Even in these cases, when the array substrate AR is attached to the counter-substrate CT, the conductive members 45 are in contact with the conductive films 41 and 42 by breaking the alignment films AL1 and AL2.

The diameter of each conductive member 45 provided in the non-intersection areas NA is Ra. The minor axis of each conductive member 45 provided in the intersection areas CA (in other words, the length in the Z-direction) is Rb. For example, minor axis Rb is less than diameter Ra by 10% or more. In this condition, the conductive film 41 can be electrically continuous with the conductive film 42 via the deformed conductive members 45 in a favorable manner.

The height of the protrusions 43a to 43c is H1. The height of the protrusions 44a and 44b is H2. In terms of conduction, diameter Ra, height H1 and height H2 should be preferably greater than or equal to ⅙ and less than ½ of the cell gap (in other words, the distance between the alignment films AL1 and AL2) in the display area DA. For example, when the cell gap is 3 μm high, diameter Ra, height H1 and height H2 can be arbitrarily determined in a range of 0.5 to 1.5 μm. Diameter Ra, height H1 and height H2 may be either the same as or different from each other.

As shown in FIG. 8, the width of the sealant 5 is W0. The width of the protrusions 43a to 43d is W1. The interval between adjacent protrusions 43 is P1. The width of the protrusions 44a and 44b is W2. The interval between the protrusions 44a and 44b is P2. The protrusions 43a to 43d may have different widths. The intervals between adjacent protrusions 43 may be different from each other. The protrusions 44a and 44b may have different widths.

When each protrusion 43 has a smooth surface like the protrusions 43b and 43c shown in FIG. 9, height H1 can be defined as, for example, the maximum height of the protrusion 43. Further, width W1 can be defined as, for example, the width of the area in which the height of the protrusion 43 is greater than or equal to 90% of height H1. The same definition is applicable to height H2 and width W2 of each protrusion 44.

For example, width W0 is greater than or equal to 100 μm and less than or equal to 500 μm. Widths W1 and W2 are greater than or equal to 5 μm and less than or equal to 20 μm. Widths W1 and W2 should be preferably greater than or equal to 5 times diameter Ra and less than or equal to 20 times diameter Ra. Interval P1 should be preferably greater than or equal to 0.7 times width W1 and less than or equal to 1.3 times width W1. It is preferable that interval P1 be substantially the same as width W1. In this condition, when the display panel 2 is manufactured, the material of the first alignment film AL formed on the protrusions 43 easily falls to the portions between adjacent protrusions 43. For the same reason, interval P2 should be preferably greater than or equal to 0.7 times width W2 and less than or equal to 1.3 times width W2. It is preferable that interval P2 be substantially the same as width W2. In the above condition, the reliability of the conduction between the conductive films 41 and 42 via the conductive members 45 is improved.

Each conductive structure 40B is the same as each conductive structure 40A explained with FIG. 8 and FIG. 9.

The effects of the present embodiment are explained.

As a comparison example, the following case is assumed. Each conductive structure 40 comprises neither the protrusions 43 nor the protrusions 44. The diameter of each conductive member 45 is substantially the same as the gap between the conductive films 41 and 42. In this comparison example, the gap between the conductive films 41 and 42 may be larger than that of the plan because of the convex and concave portions generated on the first surface SF1 and the second surface SF2. Thus, the conductive members 45 may not be sufficiently in contact with the conductive film 41 or 42. To prevent this conduction defect, the conductive materials 45 may be larger than the gap. However, the conductive members 45 are distributed in the entire sealant 5. Thus, rebounding of the conductive members 45 may occur in the entire area attached with the sealant 5. A defect may be caused in the attachment between the array substrate AR and the counter-substrate CT.

In the present embodiment, the protrusions 43 and the protrusions 44 allow the gap between the conductive films 41 and 42 to be adjusted to a desired value which does not cause the conduction defect by the convex portions and the concave portions. The conductive members 45 are in contact with the array substrate AR and the counter-substrate CT only in the areas in which the protrusions 43 face the protrusions 44. Thus, rebounding of the conductive members 45 does not occur in the entire attachment area. In this way, it is possible to prevent the defect generated in the comparison example regarding the attachment between the substrates.

When neither the protrusions 43 nor the protrusions 44 are provided, the alignment films AL1 and AL2 are formed on the conductive films 41 and 42, respectively. Thus, to ensure conduction, a step for removing the alignment films AL1 and AL2 from the surfaces of the conductive films 41 and 42 is needed. However, in a case where the protrusions 43 and the protrusions 44 are provided, the materials of the alignment films AL1 and AL2 on the protrusions 43 and the protrusions 44 flow into the vicinity at the time of forming the materials. In this way, even without a step for removing the alignment film AL1 or AL2, the first alignment film AL1 is not formed on the protrusions 43a to 43d. The first conductive film 41 is exposed. Similarly, the second alignment film AL2 is not formed under the protrusion 44a or 44b. The second conductive film 42 is exposed.

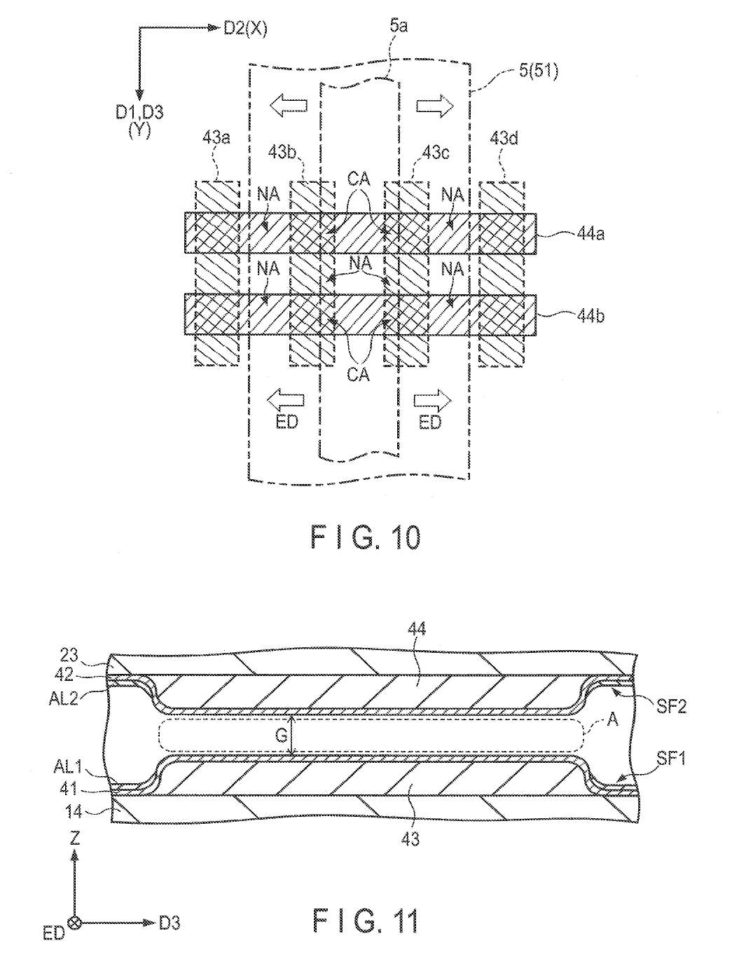

Further, each conductive structure 40 of the present embodiment is advantageous in terms of the expansion of the sealant 5 when the array substrate AR is attached to the counter-substrate CT. This effect is explained, using the plan view of FIG. 10 and the cross-sectional view of FIG. 11. As indicated with the alternate long and short dash lines in FIG. 10, in the manufacturing process of the display panel 2, a sealant 5a having a predetermined width is formed in the first surface SF1 or the second surface SF2. The sealant 5a expands in expansion directions ED as shown with the arrows when the array substrate AR is attached to the counter-substrate CT. Thus, the sealant 5 is formed. The width of the sealant 5 is, for example, approximately three times the width of the sealant 5a. When the protrusions of the conductive structure 40 are provided in a form which disturbs expansion from the sealant 5a to the sealant 5, the shape of the sealant 5 may not be a desired shape. Further, the conductive members 45 may not move to the intersection areas CA. Thus, a conduction defect may be caused.

As a form which disturbs the expansion of the sealant 5a, for example, the protrusions 43 overlap the protrusions 44 in a longitudinal direction, and further, the longitudinal direction intersects the expansion directions ED. FIG. 11 is a cross-sectional view when the display panel having the above structure is viewed in the expansion directions ED. In this example, as surrounded by the broken circle, a lengthy area A in which the distance of the gap G between the protrusion 43 and the protrusion 44 is less is formed. This area A could disturb the expansion of the sealant 5a or the move of the conductive members 45.

In the present embodiment, as shown in FIG. 8 to FIG. 10, the intersection areas CA in which the protrusions 43 intersect the protrusions 44 and the non-intersection areas NA in which the protrusions 43 do not intersect the protrusions 44 are alternately formed. In the non-intersection areas NA, the gap G is larger than that of the intersection areas CA. Thus, in comparison with the example shown in FIG. 11, the sealant 5a easily expands, and the conductive members 45 easily move. In this manner, the shape of the sealant 5 is stable. The reliability of the conduction via the conductive members 45 is improved.

In the present embodiment, each conductive structure 40 comprises the protrusions 43a and 43d which do not overlap the sealant 5. The protrusions 44a and 44b extend to positions which do not overlap the sealant 5. Further, the protrusions 44a and 44b intersect the protrusions 43a and 43d. The intersection areas CA formed by these protrusions 43a and 43d and the protrusions 44a and 44b do not contribute to the conduction between the conductive films 41 and 42. However, when misalignment occurs in the attachment between the array substrate AR and the counter-substrate CT or when the position of the sealant 5 is inappropriate, these intersection areas CA may overlap the sealant 5. The protrusions 43a and 43d serve a preliminary role for various types of misalignment and contribute to the improvement of the reliability of conduction.

As described above, in the present embodiment, the reliability of conduction between the terminal T of the array substrate AR and the detection electrodes RX of the counter-substrate CT is improved. Thus, it is possible to improve the manufacturing yield of the display device 1.

Further, each conductive structure 40A of the present embodiment is effective when the display panel 2 is bent as shown in FIG. 15. In the display panel 2 shown in FIG. 15, the array substrate AR and the counter-substrate CT are bent along first and second sides S1 and S2 near the first and second sides S1 and S2. At the positions at which the display panel 2 is bent, the surfaces of the substrates are curved. Compressive stress is applied on a side close to the center of curvature of the substrates. Tensile stress is applied on a far side. In this case, complicated stress may be applied to the sealant 5. Thus, the conductive members 45 may largely move in the first direction D1 or the second direction D2. However, in the present embodiment, the protrusions 44a and 44b extend in a direction different from that of the protrusions 43a to 43d. Thus, it is possible to control an excessive move of the conductive members 45.

Various excellent effects can be obtained from the present embodiment other than the effects explained above.

Now, other embodiments applicable to each conductive structure 40 are explained. The structures or effects which are not particularly referred to are the same as those of the first embodiment. In the second to sixth embodiments, each conductive structure 40A is explained. However, the same explanation is applicable to each conductive structure 40B. The number or layout form of protrusions 43 and protrusions 44 in each embodiment is merely an example, and may be appropriately changed.

### Second Embodiment

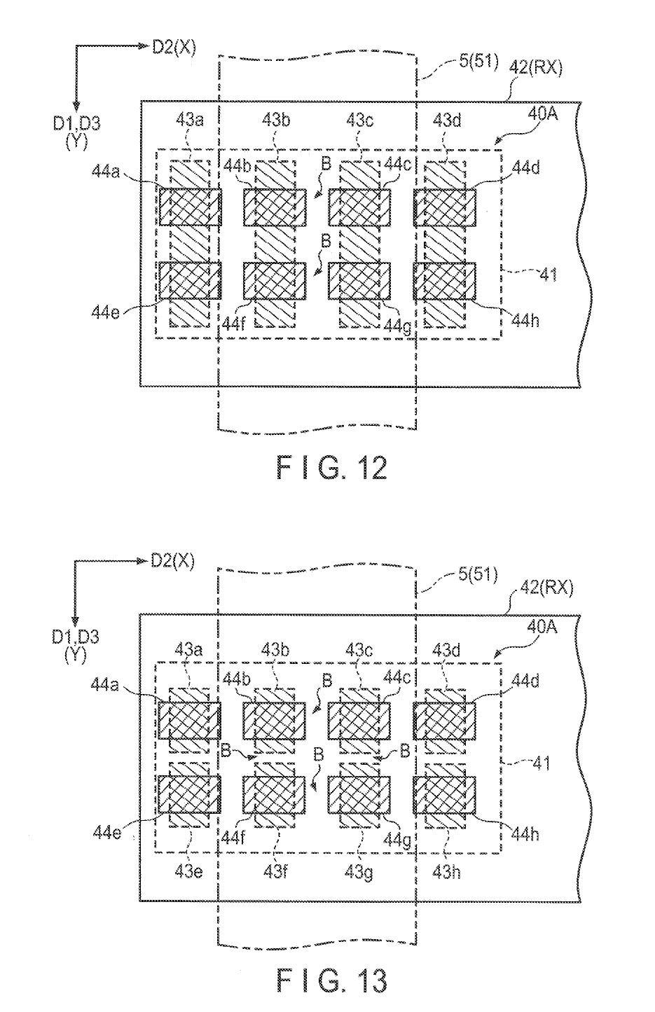

FIG. 12 is a schematic plan view of a conductive structure 40A according to a second embodiment. The conductive structure 40A comprises eight protrusions 44 (44a to 44h) provided in a counter-substrate CT. The protrusions 44a and 44e intersect a protrusion 43a. The protrusions 44b and 44f intersect a protrusion 43b. The protrusions 44c and 44g intersect a protrusion 43c. The protrusions 44d and 44h intersect a protrusion 43d. The protrusions 44a to 44d are arranged in a second direction D2. The protrusions 44e to 44h are arranged in the second direction D2.

In the present embodiment, an area B in which neither the protrusions 43 nor the protrusions 44 are present is formed between the protrusions 44 adjacent to each other in the second direction D2. The area B allows a sealant 5 to easily expand when an array substrate AR is attached to the counter-substrate CT.

### Third Embodiment

FIG. 13 is a schematic plan view of a conductive structure 40A according to a third embodiment. The conductive structure 40A comprises eight protrusions 43 (43a to 43h) provided in an array substrate AR, and eight protrusions 44 (44a to 44h) provided in a counter-substrate CT. The protrusions 43a to 43h intersect the protrusions 44a to 44h, respectively. The protrusions 43a and 43e are arranged in a first direction D1. The protrusions 43b and 43f are arranged in the first direction D1. The protrusions 43c and 43g are arranged in the first direction D1. The protrusions 43d and 43h are arranged in the first direction D1. The protrusions 43a to 43d are arranged in a second direction D2. The protrusions 43e to 43h are arranged in the second direction D2. The shape and arrangement of the protrusions 44a to 44h are the same as those of the example of FIG. 12.

In the present embodiment, an area B is formed between the protrusions 43 adjacent to each other in the first direction D1 as well as between the protrusions 44 adjacent to each other in the second direction D2. A sealant 5 more easily expands when the array substrate AR is attached to the counter-substrate CT.

### Fourth Embodiment

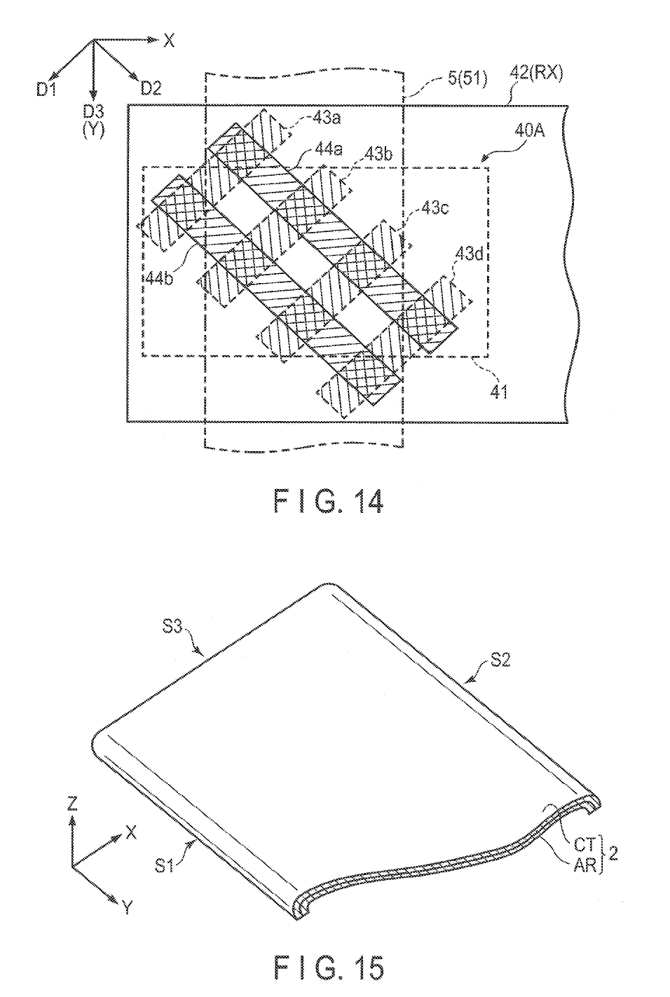

FIG. 14 is a schematic plan view of a conductive structure 40A according to a fourth embodiment. In a manner similar to that of the first embodiment, the conductive structure 40A comprises four protrusions 43 (43a to 43d) provided in an array substrate AR, and two protrusions 44 (44a and 44b) provided in a counter-substrate CT.

In the present embodiment, a first direction D1 in which the protrusions 43a to 43d extend is not parallel to a Y-direction, and a second direction D2 in which the protrusions 44a and 44b extend is not parallel to an X-direction. A third direction D3 in which a sealant 5 extends is parallel to the Y-direction. The third direction D3 intersects the first and second directions D1 and D2.

In this structure, the conductive structure 40A is strong for the stress in the X-direction or the Y-direction in comparison with the first embodiment. Thus, the reliability of conduction is further improved.

For example, the above stress is applied when the display panel 2 is bent as shown in FIG. 15. In the display panel 2 shown in FIG. 15, the array substrate AR and the counter-substrate CT are bent along first and second sides S1 and S2 near the first and second sides S1 and S2. At the positions at which the display panel 2 is bent, compressive stress is applied on a side close to the center of curvature. Tensile stress is applied on a far side. When the conductive structure 40A shown in FIG. 14 is applied to the display panel 2 in which the stress is applied in the above manner, an excellent effect can be obtained.

In the display panel 2 shown in FIG. 15, the vicinities of both the first side S1 and the second side S2 are bent. However, only the vicinity of one of the first and second sides S1 and S2 may be bent.

### Fifth Embodiment

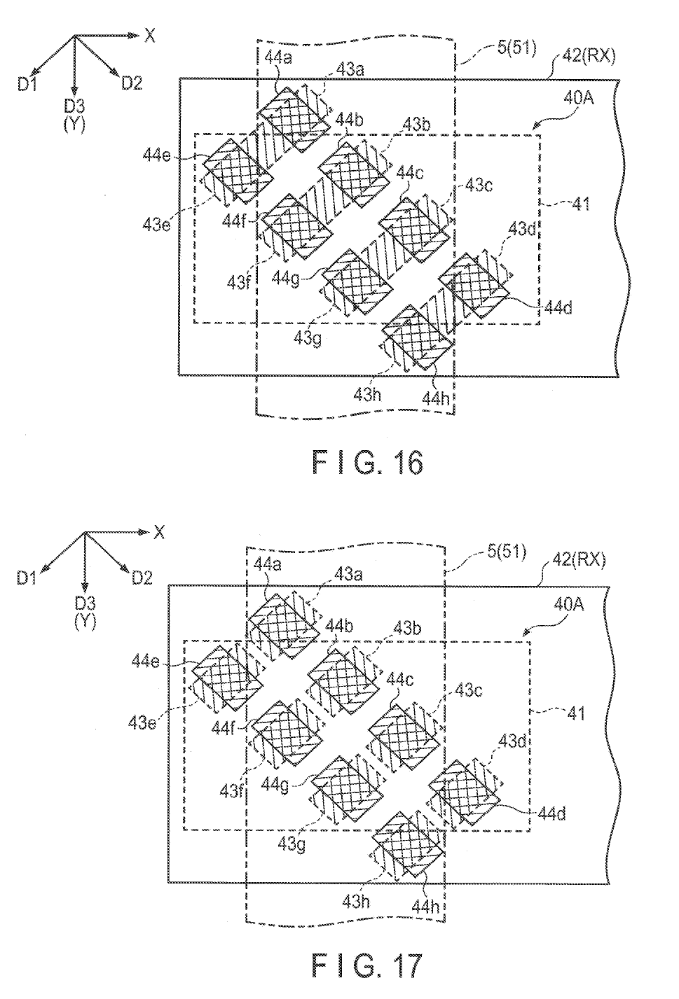

FIG. 16 is a schematic plan view of a conductive structure 40A according to a fifth embodiment. In a manner similar to that of the second embodiment, the conductive structure 40A comprises four protrusions 43 (43a to 43d) provided in an array substrate AR, and eight protrusions 44 (44a to 44h) provided in a counter-substrate CT. Further, in a manner similar to that of the fourth embodiment, a third direction D3 intersects a first direction D1 and a second direction D2.

In this structure, both the effect of the second embodiment and the effect of the fifth embodiment can be obtained.

### Sixth Embodiment

FIG. 17 is a schematic plan view of a conductive structure 40A according to a sixth embodiment. In a manner similar to that of the third embodiment, the conductive structure 40A comprises eight protrusions 43 (43a to 43h) provided in an array substrate AR, and eight protrusions 44 (44a to 44h) provided in a counter-substrate CT. Further, in a manner similar to that of the fourth embodiment, a third direction D3 intersects a first direction D1 and a second direction D2.

In this structure, both the effect of the third embodiment and the effect of the fifth embodiment can be obtained.

### Seventh Embodiment

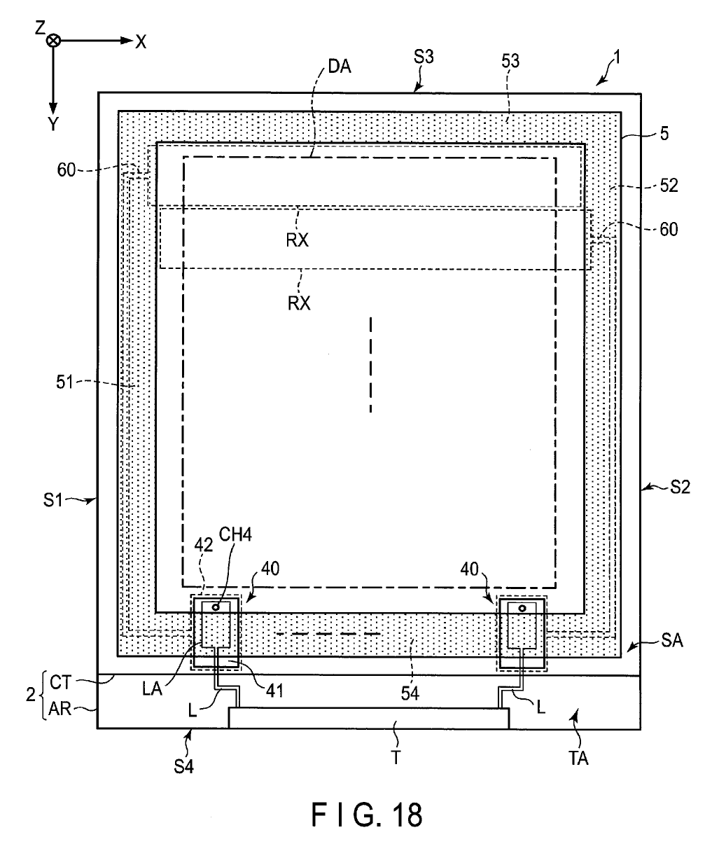

FIG. 18 is a schematic plan view of a display device 1 according to a seventh embodiment. In the present embodiment, conductive structures 40 are arranged in an X-direction between a terminal T and a display area DA. A second conductive film 42 is electrically connected to detection electrodes RX via lines 60 provided in a counter-substrate CT. For example, the lines 60 connecting the odd-numbered detection electrodes RX from a third side S3 and the conductive structures 40 pass between a first side S1 and the display area DA. The lines 60 connecting the even-numbered detection electrodes RX from the third side S3 and the conductive structures 40 pass between a second side S2 and the display area DA.

The conductive structures 40 of the present embodiment overlap a fourth portion 54 of a sealant 5. A conductive film 41 is electrically connected to the conductive film 42 via conductive members 45 included in the fourth portion 54. The structure disclosed in each of the above embodiments is applicable to the shapes, etc., of protrusions 43 and 44 included in each conductive structure 40. In the present embodiment, a third direction D3 which is the extension direction of the portion (fourth portion 54) of the sealant 5 overlapping the conductive structures 40 is parallel to an X-direction.

In the structure of the present embodiment, even when a display panel 2 is bent near the first and second sides S1 and S2, stress is not applied to the conductive structures 40. Thus, the reliability of conduction by the conductive structures 40 is improved.

### Eighth Embodiment

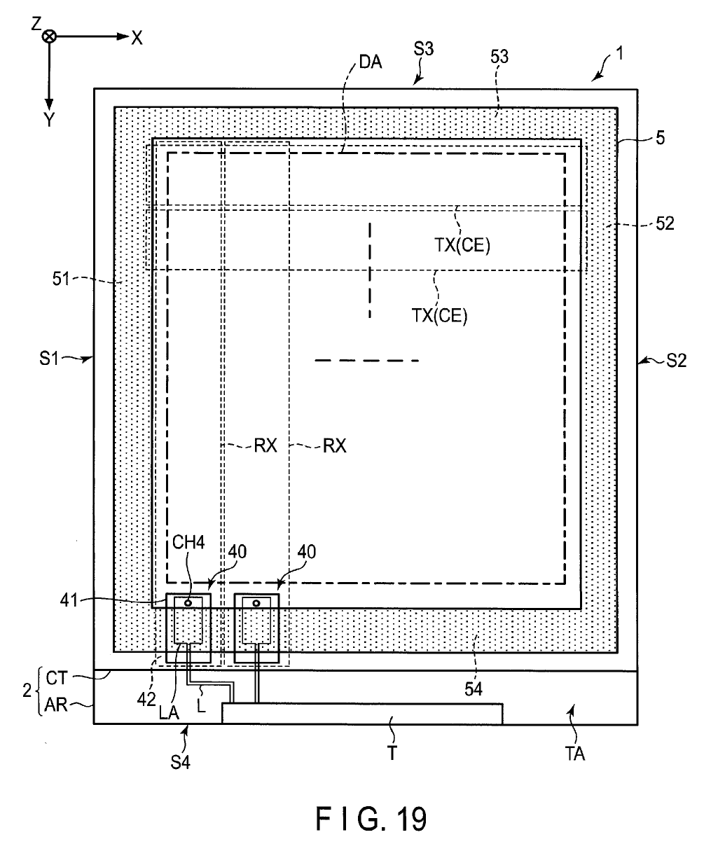

FIG. 19 is a schematic plan view of a display device 1 according to an eighth embodiment. In the present embodiment, drive electrodes TX (common electrodes CE) extend in an X-direction and are arranged in a Y-direction. Detection electrodes RX extend in the Y-direction and are arranged in the X-direction. In a manner similar to that of the seventh embodiment, conductive structures 40 are arranged in the X-direction between a terminal T and a display area DA.

In the structure of the present embodiment, there is no need to provide the lines connecting the detection electrodes RX and the conductive structures 40 or the lines connecting the conductive structures 40 and the terminal T between first and second sides S1 and S2 and the display area DA. Thus, the width of a peripheral area SA can be reduced.

The structures disclosed in the first to eighth embodiments can be appropriately changed. For example, in each embodiment, the electrodes of the counter-substrate CT as the connection target of the conductive structures 40 are the detection electrodes RX. However, the electrodes of the counter-substrate CT may be the drive electrodes TX, or other electrodes which are not related to sensing.

The sensing method is not limited to mutual capacitive sensing using the detection electrodes RX and the drive electrodes TX, and may be, for example, self capacitive sensing. When self capacitive sensing is employed, a drive signal is supplied to the electrodes of the counter-substrate CT, and a detection signal is read from these electrodes.

A part of the area of the protrusions 43 may be covered with the first conductive film 41, and the rest of the area may be exposed from the first conductive film 41. Similarly, a part of the area of the protrusions 44 may be covered with the second conductive film 42, and the rest of the area may be exposed from the second conductive film 42.

The protrusions of the conductive structures 40 may be provided in only one of the array substrate AR and the counter-substrate CT.

In each embodiment, the shapes and layout of the protrusions 43 of the array substrate AR may be replaced by those of the protrusions 44 of the counter-substrate CT. For example, to stabilize the shape of the sealant 5, of the array substrate AR and the counter-substrate CT, the protrusions of the substrate in which the sealant 5 is firstly formed at the time of manufacturing should preferably extend in the third direction D3. For example, in the structure shown in FIG. 10, the protrusions 43a to 43d extend in the third direction D3. Thus, the sealant 5 should be preferably formed in the array substrate AR. When the sealant 5 is formed in the counter-substrate CT, for example, protrusions having the same shape as the protrusions 43a to 43d should be provided in the counter-substrate CT, and protrusions having the same shape as the protrusions 44a and 44b should be provided in the array substrate AR.

Terms such as “first”, “second”, “third” and “fourth” may be added to the same or similar elements such as the protrusions, conductive structures, detection electrodes or drive electrodes (common electrodes) exemplarily shown in each embodiment to distinguish the elements from each other.

All of the display devices which may be realized by a person of ordinary skill in the art by appropriately changing the design based on the display device explained as each embodiment of the present invention fall within the scope of the present invention as long as they encompass the spirit of the invention.

Various modification examples which may be conceived by a person of ordinary skill in the art in the scope of the idea of the present invention will also fall within the scope of the invention. For example, even if a person of ordinary skill in the art arbitrarily modifies the above embodiments by adding or deleting a structural element, changing the design of a structural element, adding or omitting a step or changing the condition of a step, all of the modifications fall within the scope of the present invention as long as they are in keeping with the spirit of the invention.

Further, other effects which may be obtained from the embodiments and are self-explanatory from the descriptions of the specification or can be arbitrarily conceived by a person of ordinary skill in the art are considered as the effects of the present invention as a matter of course.

What is claimed is:

1. A display device comprising:
a first substrate comprising a first surface;
a second substrate comprising a second surface facing the first surface;
an adhesive layer which attaches the first substrate to the second substrate;
a terminal provided in one of the first and second substrates and connected to a drive circuit;
an electrode provided in the other one of the first and second substrates; and
a conductive structure which electrically connects the drive circuit and the electrode, wherein
the second substrate has flexibility, and
the conductive structure comprises:
a first protrusion provided in the first surface in an area overlapping the adhesive layer;
a first conductive film covering at least a part of the first protrusion;
a second conductive film provided in the second substrate and facing the first conductive film; and
a conductive member which is included in the adhesive layer and is in contact with the first conductive film and the second conductive film.

2. The display device of claim 1, wherein
the conductive structure further comprises a second protrusion provided in the second surface in an area overlapping the adhesive layer, and
the second conductive film covers at least a part of the second protrusion.

3. The display device of claim 2, wherein
the first protrusion extends in a first direction in a plan view, and the second protrusion extends in a second direction intersecting the first direction in a plan view.

4. The display device of claim 3, wherein
the conductive structure further comprises a third protrusion provided in the first surface, and a fourth protrusion provided in the second surface;
the first conductive film covers at least a part of the third protrusion, and the second conductive film covers at least a part of the fourth protrusion,
the third protrusion extends in the first direction in a plan view, and the fourth protrusion extends in the second direction in a plan view, and
the first protrusion and the third protrusion are arranged in the second direction in a plane view, and the second protrusion and the fourth protrusion are arranged in the first direction in a plan view.

5. The display device of claim 4, wherein
an interval between the first protrusion and the third protrusion in the second direction is greater than or equal to 0.7 times and less than or equal to 1.3 times a width of the first protrusion in the second direction.

6. The display device of claim 4, wherein
an interval between the second protrusion and the fourth protrusion in the first direction is greater than or equal to 0.7 times and less than or equal to 1.3 times a width of the second protrusion in the first direction.

7. The display device of claim 3, wherein
a first portion of the adhesive layer overlapping the conductive structure extends in a third direction intersecting the first direction and the second direction.

8. The display device of claim 1, wherein
the first substrate comprises a first side, and a second side opposite to the first side,
the display device comprises a display area between the first side and the second side in a plan view,
the conductive structure is provided between the first side and the display area or between the second side and the display area in a plan view, and
the first substrate and the second substrate are bent near at least one of the first and second sides.

9. The display device of claim 1, wherein
the first substrate comprises a first side, a second side opposite to the first side, and third and fourth sides connecting the first side and the second side,
the display device comprises a display area between the third side and the fourth side seen in a plan view,
the terminal is provided between the fourth side and the display area in a plan view,
the conductive structure is provided between the terminal and the display area in a plan view, and
the first substrate and the second substrate are bent near at least one of the first and second sides.

10. The display device of claim 1, further comprising a fifth protrusion provided in the first surface, wherein
the first conductive film covers at least a part of the fifth protrusion, and
the fifth protrusion does not overlap the adhesive layer in a plan view.

11. The display device of claim 1, wherein
the conductive member is a conductive particle, and
a width of the first protrusion is greater than or equal to 5 times and less than or equal to 20 times a diameter of the conductive particle.

12. The display device of claim 1, further comprising a liquid crystal layer between the first substrate and the second substrate, wherein
the first substrate further comprises a first alignment film which aligns liquid crystal molecules contained in the liquid crystal layer, and
an end portion of the first alignment film is closer to an end portion of the first substrate than the first protrusion in a plan view.

13. The display device of claim 12, wherein
a top portion of the first protrusion is not covered with the first alignment film or is covered with the first alignment film thinner than other areas.

14. The display device of claim 2, further comprising a liquid crystal layer between the first substrate and the second substrate, wherein
the second substrate further comprises a second alignment film which aligns liquid crystal molecules contained in the liquid crystal layer, and
an end portion of the second alignment film is closer to an end portion of the second substrate than the second protrusion in a plan view.

15. The display device of claim 14, wherein
a top portion of the second protrusion is not covered with the second alignment film or is covered with the second alignment film thinner than other areas.

16. The display device of claim 1, comprising a plurality of conductive structures including the conductive structure, wherein
the electrode comprises a plurality of sensing electrodes, and
the sensing electrodes are connected to the conductive structures different from each other.

17. The display device of claim 1, wherein
the first substrate further comprises a line electrically connecting the terminal and the first conductive film.

18. The display device of claim 17, wherein
the first substrate further comprises an insulating layer provided between the line and the first conductive film, and
the first conductive film is electrically connected to the line via a contact hole provided in the insulating layer.

19. The display device of claim 1, wherein
a height of the first protrusion is greater than or equal to ⅙ of a cell gap between the first substrate and the second substrate.

20. The display device of claim 2, wherein
a height of the second protrusion is greater than or equal to ⅙ of a cell gap between the first substrate and the second substrate.
